(19) United States
(12) Patent Application Publication
(10) Pub. No.: US 2009/0126716 A1
(43) Pub. Date: May 21, 2009

(54) U-SHAPED BURNER FOR GRILL

(75) Inventor: Tung-Sheng Kuo, Hsin Chu City (TW)

Correspondence Address: LUCAS & MERCANTI, LLP, 475 PARK AVENUE SOUTH, 15TH FLOOR, NEW YORK, NY, 10016, US

(73) Assignee: GEOGLOBAL PARTNERS, LLC, South Plainfield, NJ (US)

(21) Appl. No.: 11/943,693

(22) Filed: Nov. 21, 2007

(51) Int. Cl. F23D 14/46; F24C 3/00; A47J 37/07

(52) U.S. Cl. 126/41 R

(57) ABSTRACT

Burner for a gas grill includes an inlet section, a first straight section contiguous with the inlet section, a curved section contiguous with the first straight section, and a second straight section contiguous with the curved section and having a portion parallel to the first straight section to provide the burner with a U-shaped configuration. The curved portion has an inner side and an outer side such that the outer side has a larger radius of curvature than the inner side. The inner side of the curved portion preferably lacks apertures, and the outer side of the curved portion preferably includes apertures, such that the only exit apertures for gas being directed from the burner is through the apertures in the outer side.

### FIELD OF THE INVENTION

The present invention relates to a burner for a grill, and more specifically, to a U-shaped burner for a grill which enables improved flame generation during use of the burner.

### BACKGROUND OF THE INVENTION

U-shaped burners for grills are known in the art. One reason for using U-shaped burners is that less tubular stainless steel can be used to manufacture the burner than if the burner were, e.g., straight, while still achieving a high flame coverage area or at least a comparable flame coverage area as a straight burner.

Examples of U-shaped burners include U.S. Pat. No. 1,625,298 (Copilovich), U.S. Pat. No. 3,871,355 (Henry), U.S. Pat. No. 4,112,912 (Ballentine), U.S. Pat. No. 6,314,871 (Holbrook), U.S. Pat. No. 6,389,960 (Williams) and U.S. Pat. No. 6,553,986 (Liu) and U.S. Pub. Pat. Appln. Nos. 2003/0205223 (Schlosser), 2004/0173200 (Shoeb) and 2005/0133018 (Spangrud). Generally, flame apertures are placed on the straight portions of the U-shaped burners, and when gas is directed into the burners, e.g., from an associated propane or other fuel source, and ignited, flames emanate from the apertures along the apertures placed on the straight portions. However, at the curved portions of the known U-shaped burners, there are no apertures and therefore no flame generation during use.

### OBJECTS AND SUMMARY OF THE INVENTION

An object of the present invention is to provide an improved burner having a U-shaped configuration which improves flame coverage area along the entire length of the burner.

In order to achieve this object and possibly others, a generally U-shaped burner for a gas grill in accordance with the invention includes a gas inlet section, a first substantially straight section contiguous with the inlet section, preferably having an annular form, a curved section or portion contiguous with the first straight section, also preferably having an annular form, and a second substantially straight section contiguous with the curved section, preferably having an annular form as well. The curved section preferably has a substantially solid upper surface, a substantially solid lower surface, an inner side, and an outer side facing away from the inner side, such that the outer side has a larger radius of curvature than the inner side. The inner side is preferably solid, i.e., unperforated and lacking apertures, and the outer side preferably includes apertures, such that in the curved portion, the only exit apertures for gas being directed from the burner is through the apertures in the outer side of the curved section. In this manner, flame overlap on the inner side of the curved portion of the burner is avoided, while maximum flame coverage area is achieved in other areas surrounding the burner.

In one embodiment, the first straight section preferably includes a substantially solid upper surface, a substantially solid lower surface, an inner side, an outer side opposite the inner side, and apertures in the inner and outer sides, while the second straight section also preferably includes a substantially solid upper surface, a substantially solid lower surface, an inner side, an outer side opposite the inner side, apertures in the inner and outer sides, and a closed terminal end. The inner side of the first straight section faces the inner side of the second straight section.

One or more transverse supports may connect the first and second straight sections to provide mechanical support for the burner.

Another way to view the invention is as an annular frame including a gas inlet section, a first substantially straight section contiguous with the inlet section, a curved section contiguous with the first straight section, and a second substantially straight section contiguous with the curved section and having a portion substantially parallel to the first straight section to thereby provide the burner with a U-shaped configuration. The frame preferably has a substantially solid upper surface and a substantially solid lower surface, inner sides which face each other on the first and second straight sections, and outer sides which face away from each other on the first and second straight sections, such that the outer sides have a larger radius of curvature than the inner sides. In the curved portion, the inner side is preferably solid, and the outer side preferably includes apertures, such that the only exit apertures for gas being directed from the frame is preferably through the apertures in the outer side.

### BRIEF DESCRIPTION OF THE DRAWINGS

The following drawings are illustrative of embodiments of the invention and are not meant to limit the scope of the invention as encompassed by the claims.

FIG. 1 is a top view of burner in accordance with the invention.

FIG. 2 is a front view of the burner in accordance with the invention.

FIG. 3 is a rear view of the burner in accordance with the invention.

FIG. 4 is a cross-sectional view taken along the line 4-4 of FIG. 2.

FIG. 5 is a cross-sectional view taken along the line 5-5 of FIG. 1.

FIG. 6 is a cross-sectional view taken along the line 6-6 of FIG. 1.

### DETAILED DESCRIPTION OF THE PREFERRED EMBODIMENTS

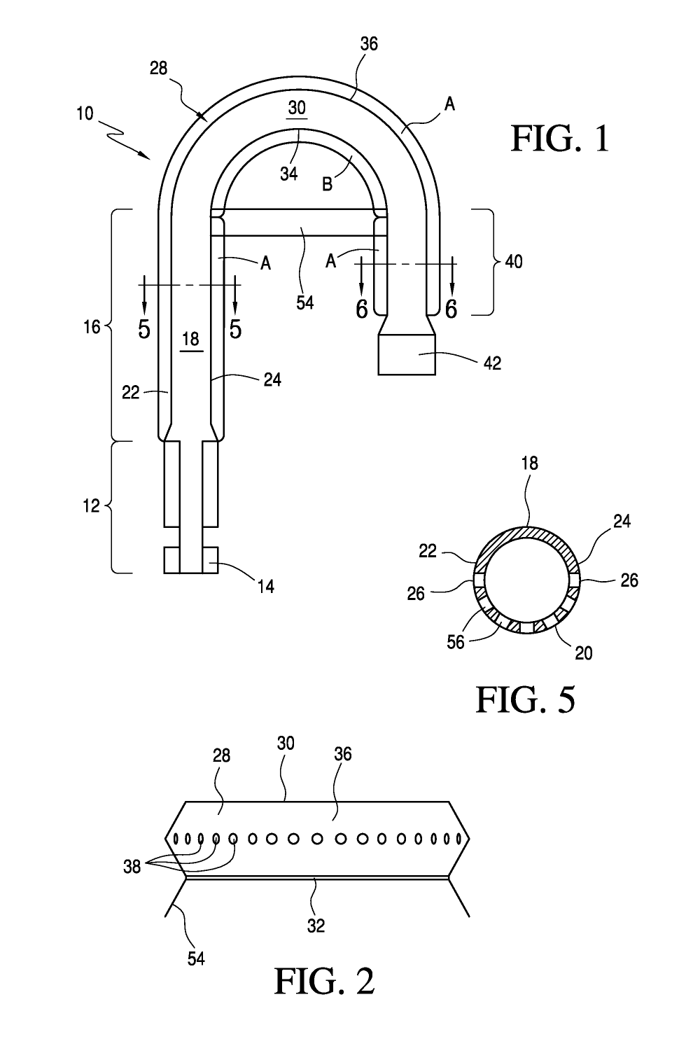

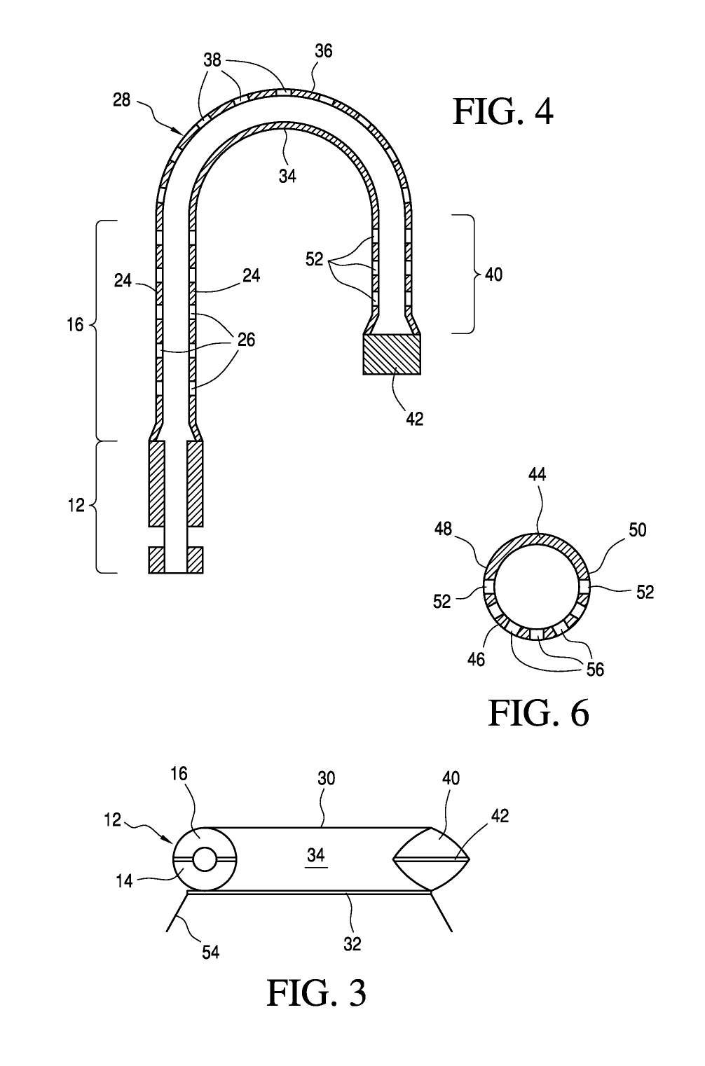

Referring to the accompanying drawings wherein like reference numerals refer to the same or similar elements, FIG. 1 is a top view of a burner in accordance with the invention which is designated generally as 10. Burner 10 includes a gas inlet section 12 which can be connected to a propane tank or any other suitable fuel source.

Burner 10 also includes a first substantially straight flame-generating section 16. First straight section 16 has a generally annular cross-section over almost its length whereas, by contrast, inlet portion 12 could have, for example, a pair of flattened portions on either side of a central conduit as illustrated in FIG. 1.

First straight section 16 preferably includes a substantially solid upper surface 18, a substantially solid lower surface 20, an inner side 24, and an outer side 22 (see FIGS. 1 and 5). The sides 22, 24 are formed from an area at the substantial mid-section or substantial mid-line of the first straight section 16, i.e., at the substantial mid-point of the distance between the highest and lowest portions of the first straight section 16. Due to the preferably generally tubular form of the first straight section 16, the sides 22, 24 will be slightly curved, while the upper and lower surfaces 18, 20 will also be preferably generally curved.

Apertures 26 are preferably formed in a pattern along both sides 22, 24 of the first straight section 16, e.g., substantially equally spaced from one another. In the illustrated embodiment, the apertures 26 on one side 22 substantially align with the apertures 26 on the other side 24 (best seen in FIG. 4), but this is not a limiting feature of the invention. Similarly, the spacing between the apertures 26 can vary on each side 22, 24, and can be different from one side to the other side, e.g., the apertures 26 may be spaced apart a first distance from one another on the inner side 24 of the first straight section 16, and a different distance on the outer side 22. Thus, there may be more apertures 26 on one side of the first straight section 16 than the other side.

Even though the first straight section 16 is preferably annular, and possibly tubular, apertures 26 are preferably formed so as to have an axis oriented in a direction substantially perpendicular to the sides 22, 24 of the first straight section 16 on which they are formed. Thus, the apertures 26 are not necessarily entirely visible in the top view as shown in FIG. 1.

Contiguous with the first straight section 16 is a curved section 28 preferably having the same general cross-sectional shape as the first straight section 16. Curved section 28 preferably extends over an arc of about 180°, i.e., it is semi-circular, but may have other arcuate dimensions or forms depending on the shape of the grill in which the burner will be used. The curved section 28 includes an upper surface 30, a lower surface 32, an inner side 34, and an outer side 36. The inner side 34 generally faces first straight section 16 and second straight section 40, while the outer side 36 faces the opposite direction, and as a consequence, outer side 36 has a larger radius of curvature than inner side 34.

Apertures 38 are formed on the outer side 36 of curved section 28 (see FIGS. 1 and 2). Preferably, apertures 38 are formed only on the outer side 36 of curved section 28, and not on the inner side 34 of curved section 28. Apertures 38 may have a pattern, e.g., be equally spaced from one another, and may also have the same spacing as apertures 26, i.e., equally spaced or alternately spaced. However, the spacing between the apertures described in this application can be modified based on the knowledge of those in the art depending on the desirable flame coverage requirements.

The absence of apertures on the inner side 34 of the curved section 28, i.e., the formation of the inner side as an unperforated or solid side, results in a limited area of flame generation along the length of the burner 10, i.e., gas is outlet and flame is generated only in the general areas designated A, and not in the general area designated B (see FIG. 1). One reason for not forming apertures on the inner side 34 is that such apertures have been found to contribute to flame overlap, i.e., when the flame provided from one aperture overlaps the flame provided from another aperture. Flame overlap is undesirable because heating is not uniform and gas is wasted, and as a result, less tubular stainless steel can be employed to achieve optimal flame coverage. Therefore, by eliminating apertures on the inner side 34 of the curved section 28, there is no issue of flame overlap in burner 10, and the amount of gas required to produce an adequate flame coverage area is significantly reduced in comparison to prior art U-shaped burners which lack any apertures in the curved portion. Moreover, the addition of apertures on outer side 36 of curved section 38 has been found to advantageously provide a greater flame coverage area compared to conventional U-shaped burners.

Contiguous with the curved section 28 is a second substantially straight section 40 which has a portion substantially parallel with the first straight section 16. Second straight section 40 preferably has a generally annular cross-section, and preferably terminates at a flattened portion 42 which seals the terminal end of the burner 10. However, it is not necessary to provide a sealed terminal end.

Second straight section 40 includes an upper surface 44, a lower surface 46, an inner side 48, and an outer side 50. The sides 48, 50 are formed from an area at the substantial mid-section or substantial mid-line of the second straight section 40, i.e., at the substantial mid-point of the distance between the highest and lowest portions of the second straight section 40. Due to the generally tubular form of the second straight section 40, the sides 48, 50 will be generally curved, while the upper and lower surfaces 44, 46 will also be generally curved.

Apertures 52 are preferably formed in a pattern along both sides 48, 50 of the second straight section 40, e.g., substantially equally spaced from one another. In the illustrated embodiment, the apertures 52 on one side 48 substantially align with the apertures 52 on the other side 50 (best seen in FIG. 4), but this is not a limiting feature of the invention. Similarly, the spacing between the apertures 52 can vary on each side 48, 50, and can be different from one side to the other side, e.g., the apertures 52 may be spaced apart a first distance from one another on the inner side 48 of the second straight section 52 and a different distance on the outer side 50. Thus, there may be more apertures 52 on one side of the second straight section 40 than the other side.

Even though the second straight section 40 is preferably annular, and possibly tubular, apertures 52 are preferably formed so as to have an axis oriented in a direction substantially perpendicular to the sides 48, 50 of the second straight section 40 on which they are formed. Thus, the apertures 52 are not necessarily entirely visible in the top view as shown in FIG. 1. Apertures 52 may have a pattern, e.g., equally spaced from one another, and may also have the same spacing as apertures 26, 38, or a different spacing which can be implemented based on the knowledge of the skilled artisan.

Burner 10 preferably includes a transverse support 54 connected at one edge region to the first straight section 16 and at a second edge region to the second straight section 40 to provide transverse stability to the burner 10. Additional transverse supports may also be provided, and/or alternative transverse supports connected at other portions of the burner may be provided as desired if necessary.

Burner 10 preferably includes apertures 56 formed on a bottom side, e.g., in one or more rows, one row on each of the first and second straight sections 16, 40. These rows function to relieve heat from the interior of the burner 10 (see FIGS. 5 and 6). In one embodiment of the invention, one set of apertures 56 are formed in a line from an aperture 26 on one side 22 of the first straight section 16 to an opposite aperture 26 on the other side 24 (FIG. 5). Another set of apertures 56 are formed in a line from an aperture 52 on one side 48 of the second straight section 40 to an opposite aperture 52 on the other side 50 (FIG. 6).

The dimensions of the U-shaped burner 10 may be selected as desired, and most likely depend on the grill in which the burner 10 is being used. In one particular embodiment, wherein the length of the space that can be occupied by a pair of burners 10 is about 23.5 inches and the width is about 16.375 inches, the first straight section 16 of each burner has a length of about 3.5 inches, and the second straight section 40 has a length of about 2 inches. The distance between the first inner side 22 of the first straight section 16 and the first inner side 48 of the second straight section 40 is about 4.5 inches, while the distance between the second outer side 24 of the first straight section 16 and the second outer side 50 of the second straight section 40 is about 6.5 inches. Naturally, the dimensions of the burner can be adjusted depending upon the size of the grill. For one type of grill, multiple burners 10 could be positioned with the second straight sections 40 of two burners 10 adjacent one another, such that the distance between the second outer sides 50 of the adjacent burners 10 is about 3.75 inches. Further, the diameter of each aperture 26,38,52 is about 0.098 inches. Again, the aperture size, spacing, burner length and burner dimensions can be adjusted as desired based on the knowledge known in the art.

Burner 10 in accordance with the invention may be formed from a single piece of annular material, or an annular frame, such as stainless steel, which is molded or otherwise formed to have the shape and form shown in the drawings. The piece of material may initially be tubular and then pressed, molded and punctured to form the portion 14, flattened portion 42 and apertures 26, 38 and 52. The optional transverse support 54 is attached to the first and second straight sections 16, 42. Further, the burner 10 may be initially straight and then bent to form the curved portion 26.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. A substantially U-shaped burner for a gas grill, comprising:
a gas inlet section;
a first straight section contiguous with said gas inlet section, said first straight section comprising apertures located on inner and outer sides of said first straight section;
a curved section contiguous with said first straight section, said curved section comprising apertures located on an outer side of said curved section; and
a second straight section contiguous with said curved section, said second straight section comprising apertures located on inner and outer sides of said second straight section.

2. The burner of claim 1, wherein said curved section is substantially semi-circular.

3. The burner of claim 1, wherein said apertures in said first and second straight sections and second curved section are substantially equally spaced from one another.

4. The burner of claim 1, wherein said first and second straight sections and said curved section have the same general cross-sectional shape.

5. The burner of claim 1, further comprising at least one transverse support connecting said first straight section to said second straight region.

6. The burner of claim 1, further comprising apertures formed on a lower surface of at least one of said first and second straight sections.

7. A substantially U-shaped burner for a gas grill, comprising:
an inlet section;
a first straight section contiguous with said inlet section;
a curved section contiguous with said first straight section, said curved section having an inner side and an outer side, such that said outer side has a larger radius of curvature than said inner side, said outer side including apertures; and
a second straight section contiguous with said curved section and substantially parallel to said first straight section,
said first straight section including apertures in inner and outer sides of said first straight section,
said second straight section including apertures in inner and outer sides of said second straight section.

8. The burner of claim 7, wherein said curved section is substantially semi-circular.

9. The burner of claim 7, wherein said apertures in said first and second straight sections and curved section are substantially equally spaced from one another.

10. The burner of claim 7, wherein said apertures on said inner side of said first straight section align with said apertures on said outer side of said first straight section, and said apertures on said inner side of said second straight section align with said apertures on said outer side of said second straight section.

11. The burner of claim 7, further comprising at least one transverse support connecting said first straight section to said second straight section.

12. The burner of claim 7, further comprising apertures formed on a lower surface of at least one of said first and second straight sections.

13. A substantially U-shaped burner for a gas grill, comprising:
an annular frame including an inlet section, a first straight section contiguous with said inlet section, a curved section contiguous with said first straight section, and a second straight section contiguous with said curved section and having a portion substantially parallel to said first straight section,
said frame having an inner side facing said inlet portion, and an outer side facing away from said inlet portion, such that said outer side has a larger radius of curvature than said inner side, said outer side including apertures, such that said curved section includes apertures for gas being directed from said frame.

14. The burner of claim 13, wherein said curved section is substantially semi-circular.

15. The burner of claim 13, wherein said apertures in said first and second straight sections and said curved section are formed in a pattern.

16. The burner of claim 13, further comprising at least one transverse support connecting said first straight section to said second straight section.

17. The burner of claim 13, wherein said first straight section includes an inner side, an outer side opposite said inner side, and apertures in said inner and outer sides, and said second straight portion includes an inner side, an outer side opposite said inner side, and apertures in said inner and outer sides, said inner side of said first straight section facing said inner side of said second straight section.

18. The burner of claim 13, wherein said apertures in said outer side of said first straight section, said outer side of said curved section, and said outer side of said second straight section are substantially equally spaced from one another.

19. The burner of claim 13, wherein said apertures on said inner side of said first straight section align with said apertures on said outer side of said first straight section, and said apertures on said inner side of said second straight section align with said apertures on said outer side of said second straight section.
